(19) United States
(12) Patent Application Publication
(10) Pub. No.: US 2016/0287472 A1
(43) Pub. Date: Oct. 6, 2016

(54) ACUPRESSURE NON-SLIP DEVICE, METHOD, AND APPARATUS FOR USE WITH EXERCISE

(71) Applicant: Katsiaryna STARZHYNSKAYA, San Diego, CA (US)

(72) Inventor: Katsiaryna STARZHYNSKAYA, San Diego, CA (US)

(21) Appl. No.: 14/678,357

(22) Filed: Apr. 3, 2015

(51) Int. Cl. A61H 39/04; A63B 21/00

(52) U.S. Cl. CPC A61H 39/04; A63B 21/1473

(57) ABSTRACT

An apparatus, method, and device for applying acupressure and/or non-slip operation during use with exercise. The surfaces of the apparatus may comprise a textured pattern that applies acupressure to points of a user when using the apparatus during a workout, and/or provides non-slip functionality. The apparatus may be for example, a mat, glove, sock, vest, or flexible footwear. The acupressure pattern may be uniform or non-uniform and cover most or only portions of the surfaces.

### FIELD OF INVENTION

The disclosed embodiments relate to an acupressure and/or non-slip device, method and apparatus for use with exercise.

### BACKGROUND OF THE INVENTION

Acupressure, like acupuncture, has been clinically proven in some studies to be beneficial to ones health. Typically, acupressure is accomplished by applying pressure to acupuncture points on the human body. Common forms of acupressure are using a small object that is somewhat rounded to apply the pressure accurately to the point. For example, a finger, thumb or combination thereof of a human, a small wooden peg with a rounded head or other object to apply the pressure.

The pressure points are located in a variety of places all over the human body. Ancient and modern pressure point “maps” suggest that all of the main body parts have a corresponding point located on the bottom of a foot and on the hands. Thus, the bottoms of feet and the hands have important acupuncture points making them a common area to treat with acupressure (e.g., reflexology, etc.). Some techniques for treating the bottoms of feet have been, for example, hard soled slippers whose insoles are covered with firm nodes in a uniformed pattern. Thus, when a person is wearing (walking around with) the hard soled slippers on, the bottoms of their feet is being targeted with the nodes to apply pressure to points. Most acupressure treatments are conducted through either specialized health clinics, or simple self-treatments like the hard soled slippers discussed above. Most treatments are provided in an environment that emphasizes relaxation.

Another healthy thing to do is regular exercise. Most healthcare experts consider regular exercise necessary to maintain health. One popular exercise to do, for example, is yoga. Yoga is more than an exercise form and there are many different types of yoga, but broadly speaking, as a common form of exercise, yoga is a variety of poses that stretch, strengthen, and tone targeted muscles and body parts. The yoga routines are orchestrated to holistically target the human body and mind. Yoga is a popular way to relieve stress as well as exercise.

One form of yoga, called Bikram yoga, involves being in a heated room typically heated around 90-105 degrees Fahrenheit. The heat makes the participants sweat and release toxins. In order to prevent injury, the participants often use a towel or yoga mat on the floor to perform the poses. The towel or mat helps cushion, for example, the back when doing some poses that require you to lay on your back on the floor. Many people do some form of exercise every day, weekly, monthly, etc. including yoga. Other forms of common exercises, for example, may include weight lifting and Pilates.

One of the problems with current exercise techniques is that the workout isn't as efficient (maximized for health) as it could be. Most people encounter time constraints in their daily lives and want to maximize their workout routines. Many people want the benefit of both exercise and acupressure, but find they have to choose one over the other due to time constraints and/or incompatible technique environments and/or equipment etc.

Another problem with current exercise equipment, for example a yoga mat, is that in some workouts they may not be secure and slip around and can cause injury. Or the user isn't able to have secure footing on them. For example, in heated yoga (e.g. Bikram), a participant is sweating and the towel or yoga mat can get slippery. This may cause their feet to slip and lose the effect of the pose, or worse injure themselves. The same problem can happen during weight lifting, Pilates and other forms of exercise.

Therefore there is a need in the art to combine the health benefits of acupressure with exercise, and to have an acupressure device, method and apparatus for use with exercise.

### SUMMARY OF THE INVENTION

In accordance with preferred embodiments of the present invention, some of the problems associated with acupressure devices are overcome. An apparatus, method, and device for applying acupressure and/or non-slip operation during use with exercise is presented.

The surfaces of the apparatus comprise one or more textured pattern that applies acupressure to points of a user when using the apparatus during a workout, and/or provides non-slip functionality. The apparatus may be for example, a mat, glove, sock, vest, or flexible footwear. The acupressure pattern may be uniform or non-uniform and cover most or only portions of the surfaces.

The foregoing and other features and advantages of preferred embodiments of the present invention will be more readily apparent from the following detailed description. The detailed description proceeds with references to the accompanying drawings.

### BRIEF DESCRIPTIONS OF THE DRAWINGS

Preferred embodiments of the present invention are described with reference to the following drawings, wherein:

FIG. 1 is a block diagram illustrating an exemplary embodiment of the present invention;

FIG. 2 is a block diagram illustrating another exemplary embodiment of the present invention;

FIG. 3 is a block diagram illustrating a footwear embodiment;

FIG. 4 is a block diagram illustrating a cross section of the footwear embodiment FIG. 3;

FIG. 5 is a block diagram illustrating a hand wear embodiment;

FIG. 6 is a block diagram illustrating an exemplary embodiment with resting embodiments;

FIG. 7 is a block diagram illustrating an exemplary embodiment with a surface with non-slip pattern components;

FIG. 8 is a block diagram illustrating an exemplary embodiment of the present invention with an hourglass shape;

FIG. 9 is a flow diagram illustrating a method for providing acupressure during exercise; and

FIG. 10 is a flow diagram illustrating a method for providing acupressure during exercise.

### DETAILED DESCRIPTIONS OF THE INVENTION

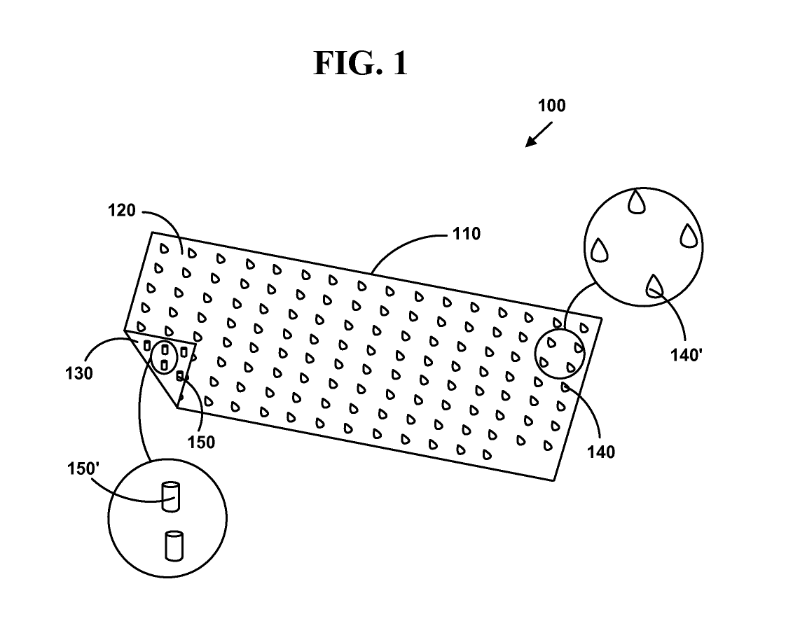

FIG. 1 is a block diagram 100 illustrating an exemplary embodiment 110 of the present invention.

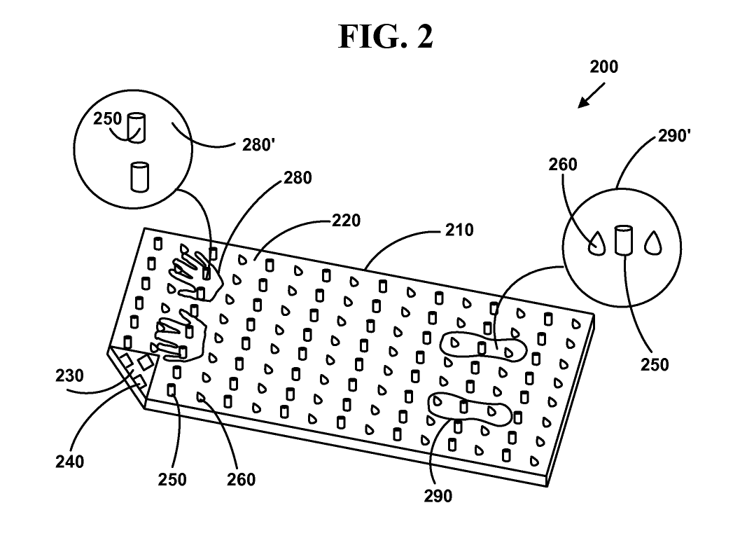

FIG. 2 is a block diagram 200 illustrating another exemplary embodiment 210 of the present invention.

In FIG. 1, the exemplary embodiment comprises a mat 110 with a top surface 120 and a bottom surface 130. The top surface 120 includes a first textured acupressure pattern 140 joined and/or attached to the top surface of the mat 110. The bottom surface 130 includes a second textured acupressure pattern 150 joined and/or attached to the bottom surface 130 of the mat 110.

The first textured acupressure pattern 140 includes a first set of plural components 140′ providing a first pre-determined resistance force to activate one or more acupressure points of a user when a weight of a portion of the user is applied to the first textured acupressure pattern 140 by the user.

The second textured acupressure pattern 150 includes a different second set of plural of components 150′ providing a second pre-determined resistance force to activate one or more acupressure points of the user when the weight of the portion of the user is applied to the second textured acupressure pattern 150 by the user.

In an embodiment, the first and second textured acupressure patterns, 140, 150 are constructed as an inherent part of the mat's surfaces. For example, an injection molding, pull-winding, molding, die cut, process create the texture as well as construct the body of the mat at the same time. A single construction process may reduce the cost and time of production.

In another embodiment, the acupressure patterns 140, 150 are joined to the mat's surface with well known appropriate construction techniques. For example, laminated, heat welding, adhesive, riveting, sewing, chemical bonding, etc.

In an embodiment, the mat 110, 210 includes yoga mat. In another embodiment, the mat includes a weight lifting mat. In yet another embodiment, the mat includes an exercise mat suitable for Pilates or other similar types of exercise (e.g. martial arts).

In an embodiment, the mat 110, 210 includes a physical surface at least 12 inches wide and at least 2 feet long. In an embodiment, the mat includes a physical surface about 24 inches wide and about 68 inches long with one half-inch (about 12 mm) total height. However, the present invention is not limited to these measurements and other measurements may be used to practice the invention.

In an embodiment, the acupressure exercise mat 110, 210, and the first and second textured acupressure pattern 140, 150 are constructed from any suitable flexible yet durable materials. For example, Ethylene-vinyl acetate (EVA), vinyl, foam, polyurethane, polymer, elastomer, thermoplastic, plastic, cloth, leather, paper, wood, bamboo, silicon, recycled materials, composite materials and rubberized material or any combination thereof. However, the present invention is not limited to these materials and other materials be used to practice the invention.

In an embodiment, the material used to construct the mat 110, 210, has a Shore A durometer value in the range between 20-90. The mat may be thinner or thicker depending on the desired application/effect. For example, the mat is between about an eighth of an inch thick to about two inches thick. In an embodiment, the mat includes padding inside in-between the top and bottom surfaces to help provide extra cushioning and support. However, the present invention is not limited to these measurements or padding and other measurements or padding may be used to practice the invention.

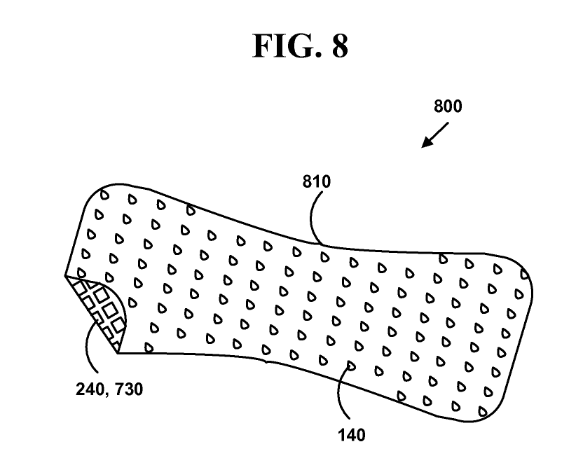

The mat's overall shape (perimeter) includes a square, oval, oblong, super ellipse, and/or hourglass shape, or any shape that provides advantages to the user. In an embodiment, the mat's overall outer shape includes an hourglass shape 810 (FIG. 8). An hourglass shape 810 is lighter to carry and easier to roll or fold up. In an embodiment, the outer perimeter of the mat may be reinforced such that it protects from tearing on stress points. For example, the outer perimeter may have a binding, or ridge. However, the present invention is not limited to these shapes and embodiments and other shapes and embodiments may be used to practice the invention.

The first and second textured acupressure patterns, 140, 150, include a variety of shapes and sizes. The pattern may allow resistance pressure at levels that isn't too intense for a user when a weight is applied to a surface. For example, when stepping on the mat with a bare foot (or in socks, etc.), or pressing with a hand (or in gloves, etc.), or laying on with one or more other body components, etc., the pressure isn't at a level that causes too much pain or discomfort for the user, but is still at a sufficient pressure to activate one or more acupressure points on the body of the user.

In an embodiment, the first and second textured acupressure patterns, 140, 150 include plural components providing a pre-determined resistance force to activate one or more acupressure points of a user when a weight is applied to the textured acupressure pattern by the user on one or more body parts of the user.

In such an embodiment, the pre-determined resistance force includes a resistance force in kilogram-force determined experimentally to be about one to about four kilograms (or about 9.8 Newtons (N) to about 39.2 N, or about 2.2 pounds force to 8.8 pounds-force).

For example, in one research article entitled “Acupressure at the Meridian Acupoint Xiyangguan (GB33) Influences Near-Infrared Spectroscopic Parameters (Regional Oxygen Saturation) in Deeper Tissue of the Knee in Healthy Volunteers” by Gerhard Litscher, Michael Ofner, Wei He, Lu Wang and Ingrid Gaischek, published in Evidence-Based Complementary and Alternative Medicine, Volume 2013 (2013), Article ID 370341, 5 pages, a human pressing on a selected acupressure point required an average (i.e., mean) force of about 30N (or about 3.06 kilograms in kilogram-force) to activate an acupressure point located on a lateral side of a human knee. This research is exemplary only and the present invention is not limited to the resistance forces described in this research and other resistance forces can be used to practice the invention.

This resistance force has been determined experimentally to be a minimal force required to activate an acupressure point on the human body without causing additional pain or discomfort for a user. However, the present invention is not limited to the resistance forces described and other resistance forces can be used to practice the invention.

In an embodiment, the acupressure pattern comprises plural nodal entities that are conical shaped 140′ with a top of the cone attached to the mat 110, 210 and a bottom of the cone (i.e., pointed part) used to apply acupressure to a user. The cones include a base diameter anywhere between 0.04 inches and 0.4 inches (between about 1 millimeter and 1 centimeter) in width. In an embodiment, the body portion of the mat, which includes the bottom and top surface of 6 mm in height, and the conical shapes 140′ protruding from the top surface of the mat as 0.24 inches (6 mm) in height giving a total mat height of 0.48 inches (12 mm). The nodule points (top of the nodule) may be rounded, or blunt. The nodule height includes anywhere between 0.04 inches (1 millimeter) and 0.78 inches (2 centimeters) high. However, the present invention is not limited to shapes or sizes described and other resistance forces can be used to practice the invention.

The nodule entities 140′ having width, height and joined and/or attached to a surface of the mat 110, 210 provide acupressure via a user standing, laying, sitting, kneeling, etc. on a surface of the mat. In other words, the user's body weight and/or exerted force presses down on the textures 140, 150 which causes the nodules to exert the pre-determined resistance force back on the acupressure points of the user to activate the pressure points.

In another embodiment, the nodule entities include rectangular 150′ cylindrical 230 (FIG. 2), square and/or triangular shaped with rounded or blunt tops.

FIG. 1 illustrates an embodiment where the first and second textured acupressure patterns, 140, 150 are distributed across the entire (or the majority of it) top surface of the mat. Majority can mean anything over 50% of the surface. Entire may mean anything over 85% of the surface.

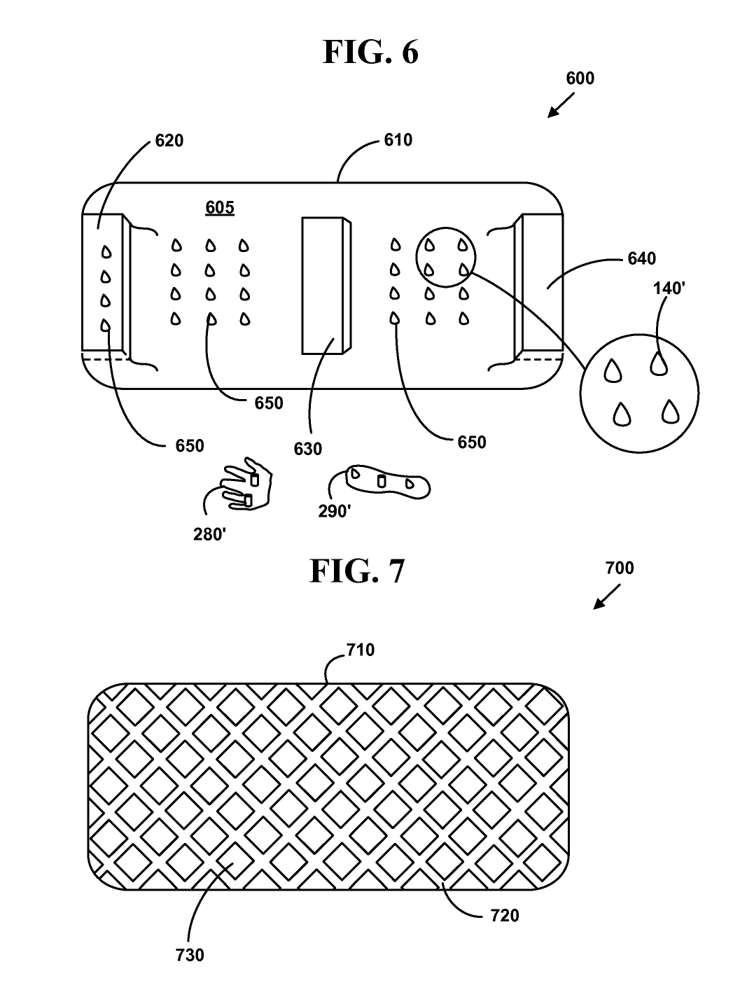

FIG. 6 illustrates an exemplary mat 610 with less than a majority (i.e., <50%, etc.) of its surfaces covered with. However, the present invention is not limited to such embodiments and other embodiments can be used to practice the invention.

In another embodiment, the entire (or the majority of it) bottom surface 130 of the mat 110, or both the top 120 and bottom surfaces 130 are covered with first and second textured acupressure patterns, 140, 150.

In an embodiment, where both surfaces 120, 130 are covered, the top surface 120 has a pattern 140 that is different from the bottom surface 130 and its pattern 150. Pattern, may mean not only where the acupressure texture is applied, but the shape and sizes of the texture as well. For example, the top surface 120 has nodules 140 that are different from the bottom surface 130 sized nodules 150, and visa-versa.

In another embodiment, the mat 210 illustrated in FIG. 2 has a top surface 220 with a textured acupressure pattern 240 and a bottom surface 230 with a non-slip patterned surface 250. This may be desirable for a variety of reasons. First, the user may use a first surface (e.g., 220) for a type of exercise (e.g., yoga with acupressure, etc.) and flip the mat over to use a second different surface (e.g., 230, etc.) for a different type of exercise (e.g. weightlifting, aerobics, etc.).

In an embodiment, the top surface 120 comprises a first pattern of uniform nodules 140, and the bottom surface 130 comprises a second different pattern 150 that is designed for non-slip (gripping functionality) that comprises ½ inch square shaped nodules with a height of ⅜ inches with ¼ inch spacing between the nodules 115. However, the present invention is not limited to such measurements and other measurements can be used to practice the invention.

The possibility of combinations of various size, shape, patterns, coverage area, etc. are numerous. One of skill in the art may readily see that many possibilities exist. Any number of combinations of size, shape, pattern, and coverage etc. for the disclosed embodiments is possible and within the scope of the discloser.

In an embodiment, the textured acupressure patterns 140, 150 are uniform and applied to the entire (or a majority) of at least one surface of the mat 110. In another embodiment, the textured acupressure patterns 250, 260 are non-uniform and applied to the entire (or a majority) of at least one surface of the mat 210.

In yet another embodiment, the textured acupressure patterns 140, 150 is uniform and applied to at least a portion of the at least one surface 120, 130 of the mat. In an embodiment, the textured acupressure patterns 250, 260 is non-uniform and applied to at least a portion of the at least one surface 220 of the mat.

Various combinations are used to target certain pressure points (e.g., hands 280 and feet 290 only, hands only 280, feet only 290, etc.), workouts, exercise modes, user's unique body builds, health goals, etc. This flexible design arrangement may maximize a user's workout experience and may provide efficient use of equipment etc.

In FIG. 2, the mat 210 has a top surface 220 and a bottom surface 230. The bottom surface has a textured pattern 240. The top surface 220 has a first set of textured acupressure patterns 250 on first a portion of the surface 220. The first pattern 250 maybe uniform with any shape and size desired, but is illustrated with plural cylinder shapes 250′.

The top surface 220 has a second set of textured acupressure patterns 260 on a second portion of the surface 220. The second pattern 250 maybe uniform with any shape and size desired, but is illustrated with plural cone shapes 260′.

The bottom surface 230 has a third set of textured patterns 240. In one embodiment, the third set of textured patterns 230 are not acupressure patterns but are instead non-slip textured patterns 230. In another embodiment, the third set of textured patterns 230 are acupressure patterns. However, the present invention is not limited to such an embodiment and other combinations and of acupressure and non-slip patterns can be used to practice the invention.

In one embodiment, the mat 210 further includes one or more first acupressure shaped patterns in the shape of a human hand 280. In such an embodiment, the human hand shape 280 includes plural of the cylinder shapes 250′ of the first set of textured acupressure patterns 250, selected and placed within the outline of the shape of the human hand 280, which are desirable to activate acupressure points on the human hand. In another embodiment, the shape of the human hand 280 is mitten shaped or paw shaped without individual fingers and/or thumbs used and not illustrated. However, the present invention is not limited to such an embodiment and other shapes and acupressure patterns can be used to practice the invention.

In such an embodiment, the mat 210 further includes one or more second acupressure shaped patterns in the shape of a human foot 290. FIG. 2 illustrates a general shape of a human foot without toes illustrated. In such an embodiment, the human foot shape includes plural of the cylinder shapes 250′ of the first set of textured acupressure patterns 240, and plural cone shapes 260′ of the second set of textured acupressure patterns 260 of selected and placed within the outline of the shape of the human foot 290, which are desirable to activate acupressure points on the human foot. In another embodiment, the shape of the human foot 290 with individual toes is used and illustrated. However, the present invention is not limited to such embodiments and other shapes and acupressure patterns can be used to practice the invention.

Various combinations of the a first set of textured acupressure patterns 250, second set of textured acupressure patterns 260 and outline of shapes 280, 290, and other shapes, etc. can be used to practice the locations. For example, the placement of the outlines of the shapes 280, 290 can be reversed and/or have the first and second set of textured acupressure patterns, 250, 260 reversed.

FIG. 2 is also not meant to limit the invention with respect to the placement of outlines of the shapes 280, 290. In addition, the outlines of the shapes 280, 290, can be placed in any location on the mat 210. The mat 210 may also be produced and sold with the outlines of the shapes 280, 290, for user of various physical heights (e.g., 5′0″, 5′1″, . . . , 6′7″, 6′8″ etc.). In such an embodiment, a user may obtain a 210 with the outline of the shapes 280, 290 that is appropriate and therefore comfortable, for his/her own physical height.

In another embodiment, the mat 210 may also be produced and sold with the outlines of the shapes 280, 290 including varying resistance forces for the acupressure points (e.g., small activating forces to large activating forces, etc.). In such an embodiment, a user may obtain a 210 with the outline of the shapes 280, 290 that is appropriate for a resisting force that is desired to activate the desired acupressure points for the user. However, the present invention is not limited to such an embodiment and other shapes and acupressure patterns can be used to practice the invention.

In another embodiment, the outlines of the shapes 280, 290 are selectively attachable and removable by a user and can be placed anywhere on the top surface 220 or bottom surface 230 of the mat. In such an embodiment, the outlines of the shapes 280′, 290′ are placed by a user as instructed by an instructor in an exercise class, or based on a preference of desired acupressure force and/or effectiveness desired by a user. However, the present invention is not limited to such an embodiment and other shapes and acupressure patterns can be used to practice the invention.

In another embodiment, the mat 610 (FIG. 6) includes a smooth top surface 605, wherein at least a portion of the top surface 605 is smooth, and the outlines of the shapes 280′, 290′, include the first set of textured acupressure patterns 250 and the second set of textured acupressure patterns 260 and/or combinations thereof. In such an embodiment, a user may selectively place the outlines of the shapes 280′, 290′ anywhere on the smooth top surface 605 of the mat 610 based on personal preferences (e.g., physical size comfort, etc.) and still receive the benefits of acupressure from the shapes 280′, 290′ during exercise. However, the present invention is not limited to such an embodiment and other shapes and acupressure patterns can be used to practice the invention.

In another embodiment, the mat 210 includes a smooth top surface 220, and the outlines of the shapes 280, 290, include the first set of textured acupressure patterns 250 and the second set of textured acupressure patterns 260 and/or combinations thereof, with differing shapes, sizes, resistances forces included by individual components of the patterns 250, 260. In such an embodiment, a user may choose a first shape 280, with a first resistance and a second shape 290 with a second resistance (e.g., more or less, than the first resistance, etc.), from a set of shapes (e.g., hands, feet. etc.) with varying acupressure resistances.

For example, a user may have an injured left foot and choose a foot shape 290′ with a large acupressure resistance for healing the foot and chose another foot shape 290″ with a normal acupressure resistance for the right foot for just activating the acupressure points for the foot. Various combinations can be used to practice the invention. However, the present invention is not limited to such an embodiment and other shapes and acupressure patterns can be used to practice the invention.

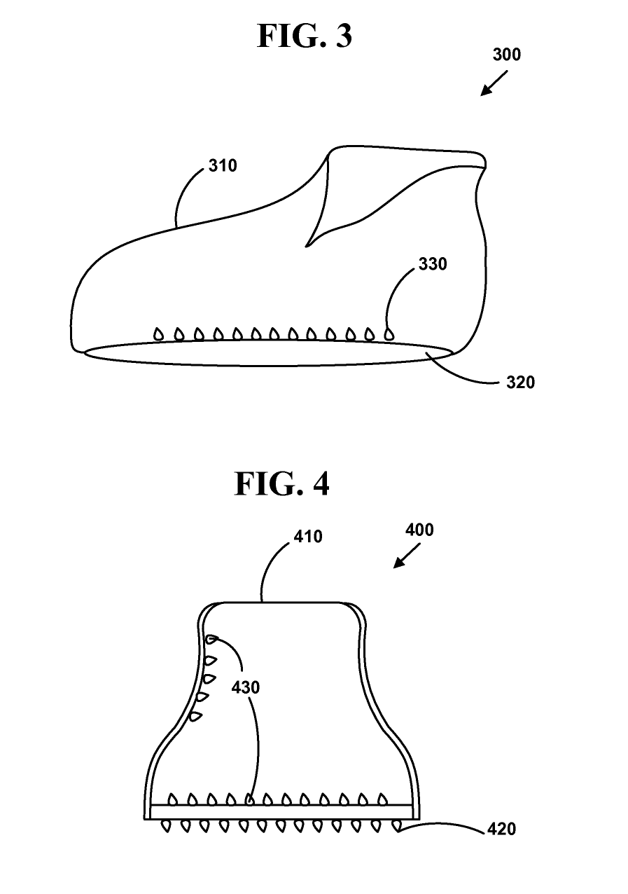

In another embodiment, the mat 210′ is smooth and the first set of textured acupressure patterns 240 and the second set of textured acupressure patterns 250 and/or combinations thereof, are placed in hand wear 710 (FIG. 7) and/or footwear 310, 410 (FIGS. 3 and 4). Such hand wear 710 and/or footwear 310, 410 is used to activate acupressure points for the user during exercise.

FIG. 3 is a block diagram 300 illustrating an acupressure slipper, sock, or footwear 310 embodiment(s).

FIG. 4 is a block diagram 400 illustrating a cross section of the footwear 310 of FIG. 3.

In an embodiment, a flexible footwear 310 is used to apply acupressure during a workout. The footwear is used with an acupressure textured and/or smooth surface mat. For example, a slipper or a sock 310 is constructed from lightweight stretchable fabric and/or materials that is appropriate for wear during yoga or a workout.

In an embodiment, the inside (insole) portion 320 of the slipper comprises a textured acupressure pattern 330. As described previously any combination of acupressure patterns is used.

A “foot-map” pattern 290 is illustrated in FIG. 2. In FIG. 4 the foot map, which comprises acupressure nodules 140, 260 (FIGS. 1 and 2) as previously described, is located outside on the bottom (i.e., sole, etc.) 420 (FIG. 4) of the slipper 310 (FIG. 3) instead of on the inside 330. Locating the pattern 420 on the outside of the sole 320 of the slipper 310 also helps create friction on the flooring surface and provide anti-slip functionality to the slipper 310. As previously described the pattern can be located both on the inside 330, 430 and/or outside surfaces 420 of the slipper 310. All of the materials, acupressure patterns and permutations described for the mat above apply to the footwear 310 as well.

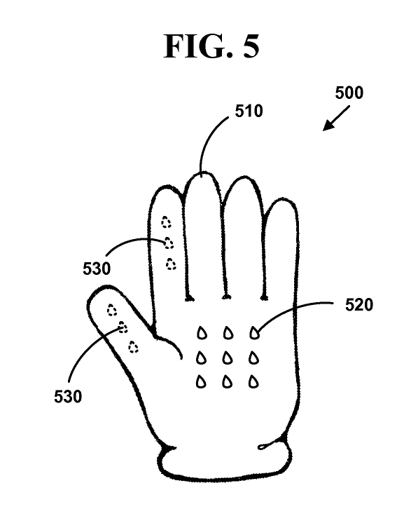

FIG. 5 is a block diagram 500 illustrating a hand wear embodiment 510. In an embodiment, a flexible glove 510 is also used to apply acupressure during a workout. The glove 510 is used with an acupressure textured and/or smooth surface mat. The glove 510 includes external 520 and/or internal 530 (illustrated as dashed lines) acupressure patterns. The glove 510 is lightweight and constructed from any number of materials as described herein for the mat 110, 210 and the footwear 310, 410. All of the materials and acupressure permutations described for the mat 110, 210 above apply to the glove 510 as well.

In an embodiment, the glove 510 includes an inside 530 textured acupressure pattern 510 that applies acupressure to portions of a human hand. As described previously any combination of acupressure patterns is used. The acupressure pattern is located on the outside 520 of the glove 510 as well. This outside embodiment may have the added benefit of providing an anti-slip functionality to the glove 510. In an embodiment the glove is used in sports such as, but not limited to, yoga, golf, cross-fit, weight lifting, surfing, rock climbing, etc.

FIG. 6 is a block diagram 600 illustrating an exemplary mat 610 with resting embodiment(s). The mat 610 comprises one or more resting components 620, 630. In an embodiment, the mat 610 comprises a footrest 620. The footrest 620 includes an area of the mat 610 located towards one end of the mat. The footrest 620 is thicker than the rest of the mat 610 to provide comfort to the user when the user is laying down (they can rest their feet on it). The footrest 620 may also be used for increasing the stretch of certain muscles when standing. For example, a user may position their toes on the footrest 620 while their heels rest on the mat's main surface, creating a stretch in the calve muscles of the legs.

In an embodiment the footrest 620 is at least 2 inches taller than the mat's main body height. In an embodiment the mat's main body height is 1 inch thick and the footrest's height is 2 inches thus creating a total overall height of 3 inches for the foot rest area. However, the present invention is not limited to such measurements and other measurements can be used to practice the invention.

Mat 610 may also comprise a knee-rest portion 630 and/or a headrest portion 640. The knee-rest 630 and the headrest 640 are areas like that as described for the footrest 620 except their locations on the mat 610 may be different.

In an embodiment the knee-rest 630 includes an area of 12-24 inches in width by 3-6 inches in length with a height of 1-3 inches above the mat's 610 main body, and the knee-rest 630 is located towards the middle of the mat. However, the present invention is not limited to such measurements and other measurements can be used to practice the invention.

In an embodiment, the headrest 640 is an area that is of 6-24 inches in width by 2-9 inches in length with a height of 1-3 inches above the mat's 610 main body, and is located towards the end of the mat 610. In an embodiment, the footrest 640 is an area of 12-24 inches in width by 2-4 inches in length with a height of 2-3 inches above the mat's 610 main body. However, the present invention is not limited to such measurements and other measurements can be used to practice the invention.

The mat 610 may comprise any of one rest areas described 620, 630, 640, any combination of two of the areas described, or all three of the rest areas. The mat 610 may comprise an acupressure pattern 650 as described above on the top and/or bottom surfaces of the mat 610 and/or a majority and/or an entirety and/or none (footwear and gloves of FIGS. 3-5 are used with the mat, etc.) of the top and/or bottom surfaces. Moreover, the pattern 650 is present on selected rest areas (e.g. 620, etc.) and/or not on the other rest areas 630, 640. In an embodiment, the rest areas (e.g., 630, 640, etc.) are not covered with the acupressure pattern 650.

FIG. 7 is a block diagram 720 illustrating a mat 710 with a surface with non-slip pattern components 720. In an embodiment the mat's 710 non-slip pattern 720 comprises non-slip or gripping functionality in the form of a specific pattern 720.

In an embodiment, the mat 710 is constructed using a material like EVA that is not slippery when moist. The non-slip pattern 720 is dimensioned such that raised squares 730 (nodules) or (diamonds depending on their orientation), may cover the entire top or bottom surface of the mat 710. The square 730 nodules are between ½ to 1 inch in diameter, with a raised height of between ¼ to ⅜ inches high, spaced ¼ to ⅜ inches apart from each other (grooves). The base (main body) portion of the mat 710 may be ⅛ thick rubberized material that the non-slip 720 pattern is adhered to. However, the present invention is not limited to such measurements and other measurements can be used to practice the invention.

FIG. 8 is a block diagram 800 illustrating an exemplary embodiment of the present invention including a mat with an hourglass shape 810.

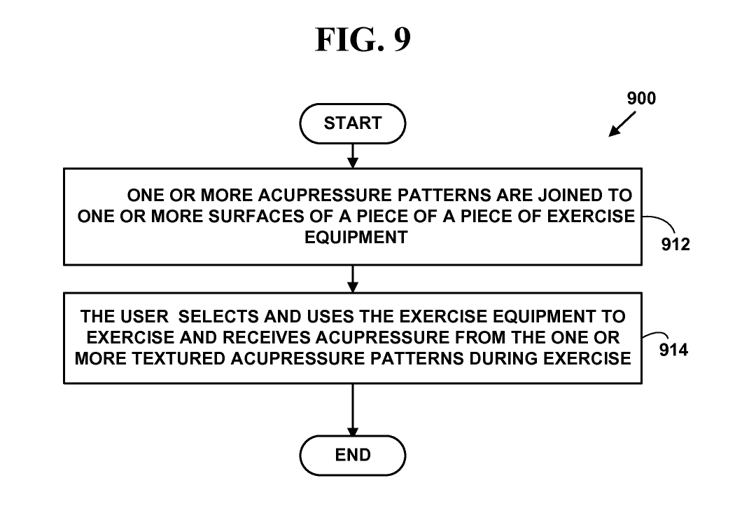

FIG. 9 is a flow diagram illustrating a Method 900 for providing acupressure during exercise. At Step 912, one or more acupressure patterns are joined to one or more surfaces of a piece of a piece of exercising including a mat, 110, 210, 610, 710, 810, glove 510, sock 310, 410, wrap, vest, seat cover, slipper 310, 410. In another embodiment, Method 900 comprises at Step 912, the step of creating during manufacture one or more textured acupressure patterns on one or more surfaces of the piece of exercise equipment such as, but not limited to, a mat 110, 210, 610, 710, 810, glove 510, sock 310, 410, seat, wrap, vest, and slipper 310, 410.

At Step 914, a user selects and uses the piece of exercise equipment created at Step 912 to exercise and receives acupressure from the one or more textured acupressure patterns 140, 150, 240, 250, 650 during exercise.

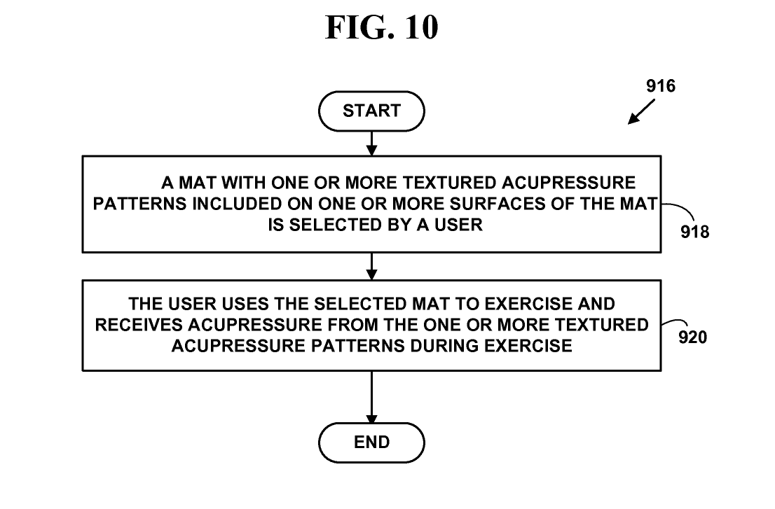

FIG. 10 is a flow diagram illustrating a Method 916 for providing acupressure during exercise. At Step 918, a mat 110, 210, 610, 710, 810 with one or more textured acupressure patterns 140, 150, 240, 250, 650 included on one or more surfaces of the mat is selected. At Step 920, a user uses the selected mat to exercise and receives acupressure from the one or more textured acupressure patterns 140, 150, 240, 250, 650 during exercise.

It should be understood that the architecture, programs, processes, methods and It should be understood that the architecture, programs, processes, methods and systems described herein are not related or limited to any particular type of materials, shapes, dimensions or pressures, unless indicated otherwise. Various types of general purpose or specialized materials, shapes, dimensions and pressures may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented various materials shapes and dimensions, in other embodiments, other materials, shapes and dimensions may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. An apparatus for providing acupressure for use with exercise, comprising:
a mat comprising a top and a bottom surface; and
a first textured acupressure pattern joined to the top surface of the mat;
a second textured acupressure pattern joined to the bottom surface of the mat;
the first textured acupressure pattern including a first set of plurality of components providing a first pre-determined resistance force to activate one or more acupressure points of a user when a weight of a portion of the user is applied to the first textured acupressure patterns by the user; and
the second textured acupressure pattern including a second set of plurality of components providing a second pre-determined resistance force to activate one or more acupressure points of the user when the weight of the portion of the user is applied to the second textured acupressure pattern by the user.

2. The apparatus of claim 1, wherein the mat includes a yoga mat.

4. The apparatus of claim 1, wherein the first or second textured acupressure pattern includes a uniform pattern applied to a majority of the top or bottom surface of the mat.

5. The apparatus of claim 1, wherein the first or second textured acupressure pattern includes a non-uniform pattern applied to a majority of the top or button surface of the mat.

6. The apparatus of claim 1, wherein the first or second textured acupressure pattern includes a uniform pattern applied to at least a portion of the top or bottom surface of the mat.

7. The apparatus of claim 1, wherein the first or second textured acupressure pattern includes a non-uniform pattern applied to at least a portion of the at least a portion of the top or bottom surface of the mat.

8. The apparatus of claim 1, wherein the first or second textured acupressure pattern includes nodules comprising rubber, EVA, foam, polyurethane, polymer, elastomer, thermoplastic, plastic, composite or rubberized material.

9. The apparatus of claim 1, wherein the mat's outer perimeter shape includes an hourglass shape.

10. The apparatus of claim 1, wherein the mat comprises one or more of a: footrest, knee-rest, and headrest.

11. The apparatus of claim 1, wherein the first and second acupressure texturized patterns comprise a same or a different pattern of conical shaped nodules.

12. The apparatus of claim 1, wherein the first and second acupressure texturized pattern comprise a same or a different pattern of raised square or rectangular or trapezoidal shaped nodules.

13. The apparatus of claim 1 wherein the first or second pre-determined resistance force to activate one or more acupressure points of the user includes a resistance force in kilograms-force of one to four kilograms.

14. The apparatus of claim 1 wherein the second textured acupressure pattern is replaced with a non-slip textured pattern.

15. The apparatus of claim 1 further including hand wear, the hand wear including a third acupressure textured pattern on selected interior or exterior surfaces of the hand wear.

16. The apparatus of claim 1 further including footwear, the footwear including a fourth acupressure textured pattern on selected interior or exterior surfaces of the footwear.

17. The apparatus of claim 1 wherein the first or second acupressure texturized patterns includes acupressure shaped patterns in the shape of a human hand or a human foot.

18. An apparatus for providing acupressure for use with exercise, comprising:
a mat comprising a top and a bottom surface; and
a first set of textured acupressure patterns selectively attachable and removable to a selected portion of the top surface of the mat in a plurality of different locations;
a second set of textured acupressure patterns selectively attachable and removable to a selected portion of the bottom surface of the mat in a plurality of different locations;
the first set of textured acupressure patterns including a first set of plurality of components providing a first pre-determined resistance force to simultaneously activate one or more acupressure points a user when a weight of a portion of the user is applied to the first textured acupressure patterns by the user; and
the second set of textured acupressure patterns including a second set of plurality of components providing a second pre-determined resistance force to simultaneously activate one or more acupressure points the user when the weight of the portion of the user is applied to the second textured acupressure patterns by the user.

19. The apparatus of claim 18 wherein the selectively attachable and removable first and second set of textured acupressure patterns include a shape of a human hand, a shape of a human foot, a shape a human head, a shape or a human neck, a human leg, a human arm, or a shape of a human torso.

20. An apparatus for providing acupressure for use with exercise, comprising:
a yoga mat comprising a top and a bottom surface; and
a first textured acupressure pattern joined to the top surface of the yoga mat;
a second textured non-slip pattern joined to the bottom surface of the yoga mat;
the first textured acupressure pattern including a first set of plurality of components providing a first pre-determined resistance force to activate one or more acupressure points of a user when a weight of a portion of the user is applied to the first textured acupressure patterns by the user; and
the second textured non-slip pattern including a second set of plurality of components providing a second pre-determined resistance force to prevent slipping of the bottom surface when a weight of portion of the user is applied to the top surface by the user.
